(19) United States
(12) Patent Application Publication
(10) Pub. No.: US 2023/0291980 A1
(43) Pub. Date: Sep. 14, 2023

(54) METHOD AND APPARATUS FOR VIDEO GENERATION AND DISPLAYING, DEVICE, AND MEDIUM

(71) Applicant: BEIJING BYTEDANCE NETWORK TECHNOLOGY CO., LTD., Beijing (CN)

(72) Inventors: Guang YANG, Beijing (CN); Shan XU, Beijing (CN); Di WU, Beijing (CN); Ling LI, Beijing (CN)

(21) Appl. No.: 18/320,508

(22) Filed: May 19, 2023

Related U.S. Application Data
(63) Continuation of application No. PCT/CN2021/131705, filed on Nov. 19, 2021.

(30) Foreign Application Priority Data
Nov. 20, 2020 (CN) 202011309792.2

(51) Int. Cl. H04N 21/81; G06T 17/00; H04N 21/2187; G06T 5/50; G06T 13/40

(52) U.S. Cl. CPC H04N 21/816; G06T 17/00; H04N 21/2187; G06T 5/50; G06T 13/40; G06T 2207/20221

(57) ABSTRACT

A video generation method is provided. The video generation method includes receiving a generation request carrying object data from a first target device; fusing the object data with a basic avatar model in response to the generation request, to obtain fused avatar images; generating a virtual gift video based on the avatar images; and sending the virtual gift video to the first target device, where the virtual gift video is used to be displayed in a target gift tray page of the first target device.

The present disclosure is a continuation of International Application No. PCT/CN2021/131705, filed on Nov. 19, 2021, which claims the priority of the Chinese patent application No. 202011309792.2, titled “METHOD AND APPARATUS FOR VIDEO GENERATION AND DISPLAYING, DEVICE, AND MEDIUM” filed on Nov. 20, 2020, with the China National Intellectual Property Administration, both of which are incorporated herein by reference in their entireties.

### TECHNICAL FIELD

The present disclosure relates to the field of video processing technology, and in particular, to a video generation and display method, a video generation and display apparatus, a device, and a medium.

### BACKGROUND

With the rapid development of computer technology and mobile communication technology, various video live platforms based on electronic devices have been widely used, greatly enriching people's daily lives. A user can conveniently watch a live video through various live video platforms and interact with an anchor of the live video, such as presenting a virtual gift to the anchor.

After logging into the live video platform, the user can customize an exclusive virtual gift in a virtual gift bar, to design a virtual gift that can convey the user′ demand by the live video platform. At present, a virtual gift video can generally be designed on the live video platform manually, which has a long production cycle and high cost.

### SUMMARY

In order to solve the above technical problems or at least partially solve them, a video generation and display method, a video generation and display apparatus, a device, and a medium are provided in the present disclosure.

In a first aspect, a video generation method is provided according to the present disclosure. The video generation method includes:
receiving a generation request carrying object data from a first target device;
fusing the object data with a basic avatar model in response to the generation request, to obtain fused avatar images;
generating a virtual gift video based on the avatar images; and
sending the virtual gift video to the first target device, where the virtual gift video is used to be displayed in a target gift tray page of the first target device.

In a second aspect, a video display method is provided according to the present disclosure. The video display method includes:
obtaining object data, in response to detecting a generation operation inputted by a user;
sending a generation request carrying the object data to a second target device, where the generation request is configured to provide a virtual gift video that is fed back from the second target device and generated by fusing the object data with a basic avatar model;
receiving the virtual gift video fed back from the second target device; and
displaying the virtual gift video in a target gift tray page.

In a third aspect, a video generation apparatus is provided according to the present disclosure. The video generation apparatus includes:
a first receiving unit configured to receive a generation request carrying object data, from a first target device;
a first fusion unit configured to fuse the object data with a basic avatar model in response to the generation request, to obtain fused avatar images;
a video generation unit configured to generate a virtual gift video based on the avatar images; and
a first sending unit configured to send the virtual gift video to the first target device, where the virtual gift video is used to be displayed in a target gift tray page of the first target device.

In a fourth aspect, a video display apparatus is provided according to the present disclosure. The video display apparatus includes:
a first obtaining unit configured to obtain object data, in response to detecting a generation operation inputted by a user;
a second sending unit configured to send a generation request carrying the object data to a second target device, where the generation request is configured to enable the second target device to provide a virtual gift video that is fed back from the second target device and generated by fusing the object data with a basic avatar model;
a second receiving unit configured to receive the virtual gift video from the second target device; and
a video display unit configured to display the virtual gift video in a target gift tray page.

In a fifth aspect, a computing device is provided in the present disclosure. The computing device includes:
a processor;
a memory, configured to store executable instructions;
where the processor is configured to read the executable instructions from the memory and execute the executable instructions to implement the video generation method described in the first aspect or the video display method described in the second aspect.

In a sixth aspect, a computer-readable storage medium storing a computer program is provided according to the present disclosure. The computer program, when executed by a processor, causes the processor to implement the video generation method described in the first aspect or the video display method described in the second aspect.

The technical solution provided in the embodiments of the present disclosure has the following advantages compared to the conventional technology.

According to a video generation and display method, a video generation and display apparatus, a device, and a medium according to the embodiments of the present disclosure, the object data is fused with a basic avatar model to obtain fused avatar images, and a virtual gift video to be displayed in the target gift tray page is generated based on the avatar images. In this way, the virtual gift video is generated automatically, thereby shortening the production cycle of the virtual gift video, and saving the production cost of the virtual gift video.

### BRIEF DESCRIPTION OF THE DRAWINGS

The above and other features, advantages, and aspects of the embodiments of the present disclosure will become more apparent in combination with the accompanying drawings and with reference to the following detailed description. Throughout the accompanying drawings, identical or similar reference numerals represent identical or similar elements. It should be understood that the accompanying drawings are schematic, and the components and elements may not necessarily be drawn to scale.

FIG. 1 is a diagram showing an application environment architecture of a video generation method according to an embodiment of the present disclosure;

FIG. 2 is a diagram showing an application environment architecture of a video generation method according to another embodiment of the present disclosure;

FIG. 3 is a schematic flowchart of a video generation method according to an embodiment of the present disclosure;

FIG. 4 is a schematic flowchart of a method for sending a virtual gift video according to an embodiment of the present disclosure;

FIG. 5 is a schematic flowchart of a method for sending a virtual gift video according to another embodiment of the present disclosure;

FIG. 6 is a schematic flowchart of a video display method according to an embodiment of the present disclosure;

FIG. 7 is a schematic diagram of a gift tray interface according to an embodiment of the present disclosure;

FIG. 8 is a schematic diagram of a data upload interface according to an embodiment of the present disclosure;

FIG. 9 is a schematic structural diagram showing a video generation apparatus according to an embodiment of the present disclosure;

FIG. 10 is a schematic structural diagram showing a video display apparatus according to an embodiment of the present disclosure; and

FIG. 11 is a schematic structural diagram showing a computing device according to an embodiment of the present disclosure.

### DETAILED DESCRIPTION OF THE EMBODIMENTS

The embodiments of the present disclosure will be described in more detail below with reference to the accompanying drawings. Although certain embodiments of the present disclosure are shown in the accompanying drawings, it should be understood that the present disclosure can be implemented in various forms and should not be construed as limited to the embodiments described here. On the contrary, these embodiments are provided for a more thorough and complete understanding of the present disclosure. It should be understood that the accompanying drawings and embodiments disclosed in the present disclosure are only for illustrative purposes and are not intended to limit the scope of protection of the present disclosure.

It should be understood that the various steps disclosed in the method embodiment of the present disclosure can be executed in different orders and/or in parallel. In addition, the method embodiment may include additional steps and/or omit to perform the illustrated steps. The scope of the present disclosure is not limited in this regard.

The term “include” and its variations used in the present disclosure are open-ended, meaning “include but not limited to”. The term “based on” refers to “at least partially based on”. The term “an embodiment” means “at least one embodiment”. The term “another embodiment” means “at least one another embodiment”. The term “some embodiments” means “at least some embodiments”. The relevant definitions of other terms will be given in the following description.

It should be noted that the concepts such as “first” and “second” mentioned in the present disclosure are only used to distinguish from different apparatuses, modules or units, and are not intended to limit an sequential order or interdependence of the functions performed by these apparatuses, modules or units.

It should be noted that the modifications of “one” and “multiple” mentioned in the present disclosure are indicative rather than restrictive, and those skilled in the art should understand that unless otherwise explicitly stated in the context, they should be understood as “one or more”.

Names of messages or information exchanged between multiple apparatuses in the embodiments of the present disclosure are for illustrative purposes only and are not intended to limit the scope of the messages or information.

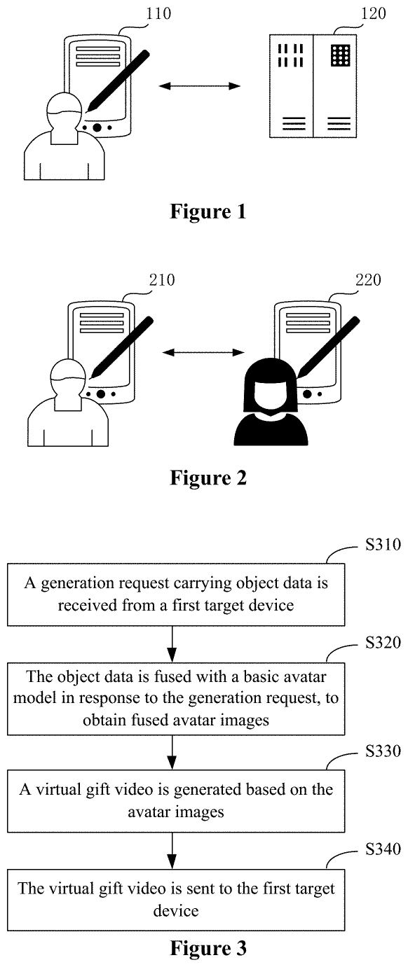

The video generation and display method according to the present disclosure may be applied to architectures shown in FIGS. 1 and 2, which will be explained in detail in conjunction with FIGS. 1 and 2.

FIG. 1 is a diagram showing application environment architecture of a video generation method according to an embodiment of the present disclosure.

As shown in FIG. 1, the architecture includes at least one electronic device 110 on the client side and at least one server 120 on the server side. The electronic device 110 establishes a connection and exchange information with the server 120 through network protocols such as Hyper Text Transfer Protocol over Secure Socket Layer (HTTPS). The electronic device 110 is a device with communication functions, such as a mobile phone, a tablet computer, a desktop computer, a laptop, a car terminal, a wearable device, an all-in-one machine, a smart home device; and may also be a device simulated by a virtual machine or a simulator. The server 120 is a device with storage and computing capabilities, such as a cloud server or a cluster of servers.

Based on the above architecture, a user applies to customize a virtual gift video in a live video platform on the electronic device 110. The live video platform creates a virtual gift video for the user based on the customized application from the user.

Therefore, in order to improve the production efficiency of the virtual gift video and save the production cost of the virtual gift video, the virtual gift video is generated with the following method. Here, the description is made with the live video platform being the live video application as an example. When detecting a generation operation for generating the virtual gift video inputted by the user, the electronic device 110 obtains object data of the user and sends a generation request carrying the object data to the server 120. After receiving the generation request carrying the object data from the electronic device 110, the server 120 fuses the object data with a basic avatar model to obtain fused avatar images, generates the virtual gift video based on the avatar images, and then sends the virtual gift video to electronic device 110. The electronic device 110 receives the virtual gift video fed back from the server 120 and displays the virtual gift video in a target gift tray page.

Therefore, the virtual gift video can be generated automatically by the architecture shown in FIG. 1, thereby shortening the production cycle of the virtual gift video and saving the production cost of the virtual gift video.

Besides the architecture composed of the electronic device and the server mentioned above, the video generation method and the video display method according to the embodiments of present disclosure may also be applied to an architecture composed of multiple electronic devices, as explained in detail in FIG. 2.

FIG. 2 is a diagram showing application environment architecture of a video generation method according to another embodiment of the present disclosure.

As shown in FIG. 2, the architecture includes at least one first electronic device 210 and at least one second electronic device 220. The first electronic device 210 establishes a connection and exchange information with the second electronic device 220 through a network protocol, such as HTTPS. The first electronic device 210 and the second electronic device 220 are each a device with communication functions, such as a mobile phone, a tablet computer, a desktop computer, a laptop, a car terminal, a wearable device, an all-in-one machine, a smart home device; and may also be a device simulated by a virtual machine or a simulator.

Based on the above architecture, a user of the first electronic device 210 sends an application for customizing a virtual gift video to a user of the second electronic device 220 through the first electronic device 210. The user of the second electronic device 220 creates the virtual gift video for the user of the first electronic device 210 based on the received application.

Therefore, in order to improve the production efficiency of the virtual gift video and save the production cost of the virtual gift video, the virtual gift video is generated with the following method. When detecting a generation operation for generating the virtual gift video inputted by the user, the first electronic device 210 obtains object data of the user and sends a generation request carrying the object data to the second electronic device 220. After receiving the generation request carrying the object data from the first electronic device 210, the second electronic device 220 fuses the object data with a basic avatar model to obtain fused avatar images, generates the virtual gift video based on the avatar images, and then send the virtual gift video to the first electronic device 210. The first electronic device 210 receives the virtual gift video fed back from the second electronic device 220 and displays the virtual gift video in a target gift tray page.

Therefore, the virtual gift video can be generated automatically by the architecture shown in FIG. 2. After the second electronic device 220 receives the generation request carrying the object data from the first electronic device 210, the user of the second electronic device 220 does not need to manually create the virtual gift video, thereby shortening the production cycle of the virtual gift video and saving the production cost of the virtual gift video.

Based on the above architecture, a video generation method and a video display method according to the embodiments of the present disclosure will be explained in conjunction with FIGS. 3 to 8 below. In some embodiments, the video display method may be executed by a first target device. The first target device may be the electronic device 110 on the client side shown in FIG. 1 or the first electronic device 210 shown in FIG. 2. In other embodiments, the video generation method may be executed by a second target device. The second target device may be the server 120 on the server side shown in FIG. 1 or the second electronic device 220 in FIG. 2. The electronic device 110, first electronic device 210, and second electronic device 220 are each a device with communication functions, such as a mobile phone, a tablet computer, a desktop computer, a laptop, a car terminal, a wearable device, an all-in-one machine, a smart home device; and may also be a device simulated by a virtual machine or a simulator. The server 120 may be a device with storage and computing capabilities, such as a cloud server or a cluster of servers.

FIG. 3 is a schematic flowchart of a video generation method according to an embodiment of the present disclosure.

As shown in FIG. 3, the video generation method includes the following steps.

In S310, a generation request carrying object data is received from a first target device.

When a user wants to customize a virtual gift video, the user may send a generation request carrying object data to a second target device using the first target device. The second target device may automatically generate a customized virtual gift video for the user based on the object data, in response to the generation request.

In some embodiments of the present disclosure, the object data includes at least one of object information, an object posture image, and a part image of an object. In an embodiment, the object may be an object who requests to generate the virtual gift video, for example a user who requests to generate the virtual gift video. The object data may be a data input by the object. The user may request to use the input object data to generate the virtual gift video.

In an embodiment, the object information may include at least one of object identification, an object nickname, and an object display picture.

The object identification may be a user account.

In an embodiment, the object posture image may include at least one of a first posture image for a first part of an object and a second posture image for a second part of the object.

The object data may include at least one second posture image of the object. In the case that the object data includes two or more second posture images of the object, the second part postures in the two or more second posture images form a continuous second part movement. The two or more second posture images also each contain an independent second part posture. For example, the second part may be the body of the object, and the second posture image may include posture movements of the second part.

In the case that the second part postures in the two or more second posture images form a continuous second part movement, the two or more second posture images are consecutive image frames in a second part movement video uploaded by the user. The second part movement video may be used as the object data, to enable the second target device to obtain two or more second posture images of the object from the second part movement video.

The object data may include at least one first posture image of the object. In the case that the object data includes two or more first posture images of the object, the first part postures in the two or more first posture images form a continuous first part movement. The two or more first posture images also contain independent first part postures. For example, the first part may be a part of the object other than the second part, such as a head of the object. The first posture image may include the postures of the first part.

In the case that the first part postures in the two or more first posture images form a continuous first part movement, the two or more first posture images are consecutive image frames in a first part movement video uploaded by the user. The first part movement video may be used as the object data to enable the second target device to obtain two or more first posture images of the user from the first part movement video.

In addition, a full second part movement video of the user may also be used as the object data, to enable the second target device to obtain two or more full second posture images of the user from the full second part movement video. The full second posture image may include the first part posture and the second part posture.

In S320, the object data is fused with a basic avatar model in response to the generation request, to obtain fused avatar images.

For example, after receiving the generation request, the second target device first obtains a pre-set basic avatar model in respond to the generation request, and then fuses the object data carried in the generation request with the basic avatar model to obtain the fused avatar model, and then generates the fused avatar image using the fused avatar model.

In some embodiments of the present disclosure, in the case that the object data includes an object posture image, and the object posture image includes at least one of a first posture image for a first part of the object and a second posture image for a second part of the object, S320 may specifically include:
performing posture transfer on the basic avatar model using the object posture image to generate the fused avatar image.

In some embodiments, in the case that the object posture image includes the second posture image for the second part of the object, the second part postures in respective second posture images may be transferred to the basic avatar model using a deformation transfer technique (such as, deformation transfer technique for triangular mesh), to obtain a fused avatar model corresponding to the second posture images, which is an avatar model with the second part postures in the respective second posture images. Then, the fused avatar image corresponding to the respective second posture images is generated using the fused avatar model corresponding to the respective second posture images.

Specifically, the basic avatar model may be pre-set with multiple preset second part postures. After receiving the generation request, the second target device first creates a network model of the user using the respective second posture images, to obtain a source model corresponding to the respective second posture images. Then, a basic avatar model with a preset second part posture similar to that in any one of second posture images is selected, to construct a mesh model of the basic avatar model and obtain a target model. Next, a deformation relationship between the source model and the target model with similar second part postures is determined. Finally, the posture of each source model is transferred to the target model separately, based on the determined deformation relationship in the deformation transfer technique, to obtain the fused avatar model.

Therefore, the second part posture of the avatar in the virtual gift video generated using the avatar model is associated with the user applying to customize a virtual gift video, improving the user experience.

In other embodiments of the present disclosure, in the case that the object data includes the part image of the object, S320 may specifically include:
updating the basic avatar model using the part image of the object, to generate a fused avatar image.

Therefore, the first part of the avatar in the virtual gift video generated using the avatar model is associated with the user applying to customize a virtual gift video, improving the user experience.

In still other embodiments of the present disclosure, in the case that the object data includes object information, and the object information includes at least one of an object identification, an object nickname, and an object display picture, S320 may specifically include:
generating an avatar image corresponding to the basic avatar model;
adding object information to a preset position of the avatar image based on a preset information addition method, to generate a fused avatar image.

The basic avatar model may be preset with multiple preset posture combinations. The preset posture combinations may include multiple preset postures. Multiple preset postures form a continuous movement, such as likes and greetings. The preset posture may include at least one of a preset second part posture and a preset first part posture. After receiving the generation request, the second target device first generates multiple avatar images in different preset posture combinations using the basic avatar model, and then adds the object information to the preset position of the avatar images based on the preset information addition method to generate the fused avatar images.

In an embodiment, the preset information addition method may include at least one of preset font color, preset font background, and preset display effect. The preset position may be any position in the avatar image, which may be set as needed.

Therefore, the object information of the avatar in the virtual gift video generated using the avatar model is associated with the object information of the user applying to customize a virtual gift video, increasing the user's sense of participation, and further improving the user experience.

In some embodiments of the present disclosure, in the case that the object data include two or more of the object information, the object posture image, and the part image of the object, each type of object data is fused into the basic avatar model using a fusion method of this type of the object data with the basic avatar model, to obtain the fused avatar image.

In an embodiment of the present disclosure, the basic avatar model may be at least one of a cartoon image model and a virtual character model. The following description is given with the base avatar model being a cartoon image model or the base avatar model being a virtual character model as an example.

In the case that the basic avatar model is a cartoon image model, the customized virtual gift video may be a small size of gift video. In this case, the user sends a generation request carrying second posture images to the second target device, and the second part postures in the second posture images form a continuous second part movement. The second target device automatically transfers the second part postures in the second posture images to the cartoon image model in respond to the generation request, to generate the fused avatar image.

In the case that the basic avatar model is a virtual character model, the customized virtual gift video may be a large gift video. In this case, the user sends a generation request carrying second posture images, first posture images and a part image of an object to the second target device, the second part postures in the second posture images form a continuous second part movement, and the first part postures in the first posture images form continuous a first part movement. The second target device automatically replaces the first part of the virtual character model with the first part in the part image of the object; and then transfers the second part postures in the second posture images and the first part postures in the first posture images to the cartoon image model, in respond to the generation request, to finally generate the fused avatar images.

In S330, a virtual gift video is generated based on the avatar images.

In some embodiments of the present disclosure, the second target device renders the avatar images, and combines and continuously plays the rendered avatar images to generate a virtual gift video in which the avatar makes a continuous movement.

In other embodiments of the present disclosure, audio data may also be obtained. The virtual gift video may be generated using the avatar images and the audio data.

Specifically, the audio data may be audio data carried in the generation request and specified by the user, or pre-set audio data, which will not be limited herein.

The second target device obtains the audio data, and then renders the avatar images, and combines and continuously plays the rendered avatar image to generate the virtual gift video in which the avatar makes a continuous movement. Finally, the audio data is added to the virtual gift video, based on timing of the frame image in the virtual gift video and timing of the audio data.

In S340, the virtual gift video is sent to the first target device, where the virtual gift video is displayed in a target gift tray page of the first target device.

In an embodiment of the present disclosure, the second target device sends the virtual gift video to the first target device after the virtual gift video is generated. The first target device displays the received virtual gift video in the target gift tray page.

In an embodiment of the present disclosure, the object data may be fused with the basic avatar model to obtain the fused avatar images. The virtual gift video to be displayed on the target gift tray page is generated based on the avatar images, to achieve automatic generation of the virtual gift video, thereby shortening the production cycle of the virtual gift video and saving the production cost of the virtual gift video.

In another embodiment of the present disclosure, after S340, when a user of the first target device requests to present a customized virtual gift video to an anchor of a target live room, the second target device causes the electronic device that is displaying a live video from the target live room to display the virtual gift video.

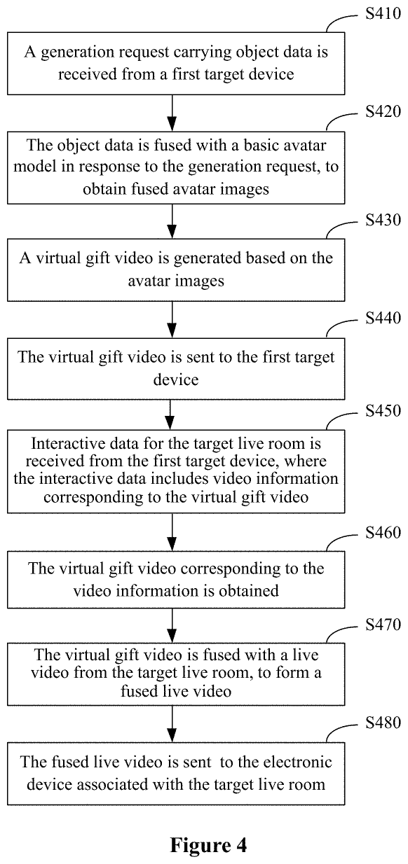

FIG. 4 is a flowchart of a method for sending a virtual gift video according to an embodiment of the present disclosure.

In some embodiments of the present disclosure, the method for sending a virtual gift video may further include the following steps S410 to S480,

In S410, a generation request carrying object data is received from a first target device.

In S420, the object data is fused with a basic avatar model in response to the generation request, to obtain fused avatar images.

In S430, a virtual gift video is generated based on the avatar images.

In S440, the virtual gift video is sent to the first target device, where the virtual gift video is used to be displayed in a target gift tray page of the first target device.

S410 to S440 are similar to S310 to S340 shown in FIG. 3, which will not be repeated herein.

In S450, interactive data for the target live room is received from the first target device, where the interactive data includes video information corresponding to the virtual gift video.

When a user wants to send the virtual gift video in the target live room, the video information corresponding to the virtual gift video may be sent from the first target device to the second target device. The video information carries a live room ID of the target live room, so that the second target device knows a destination object of the virtual gift video.

In some embodiments, the video information may include at least one of a video ID of the virtual gift video and a video name of the virtual gift video.

In other embodiments, the interactive data may also include a presentation time of the virtual gift video.

In yet other embodiments, the interactive data may also include user comment information, user operation information, etc.

In S460, the virtual gift video corresponding to the video information is obtained.

In an embodiment of the present disclosure, after receiving the video information, the second target device queries the virtual gift video corresponding to the video information in multiple pre-stored virtual gift videos.

In S470: the virtual gift video is fused with a live video from the target live room, to form a fused live video.

In an embodiment of the present disclosure, the second target device adds the virtual gift video to the live video based on the timing of frame images in the live video and the timing of frame images in the virtual gift video.

In some embodiments, the first frame image of the live video, in which the virtual gift video is added, is determined based on the presentation time of the virtual gift video. Then, based on the timing of the frame images in the live video and the timing of the frame images in the virtual gift video, each frame image in the virtual gift video is added to a target position of the corresponding frame image in the live video, to add the virtual gift video to the live video.

The target position may be the middle, bottom, left or right of the image, which will not be limited herein.

In S480, the fused live video is sent to the electronic device associated with the target live room.

In an embodiment of the present disclosure, the second target device sends the fused live video to the electronic device associated with the target live room, after the fused live video is formed.

The electronic device associated with the target live room may be an electronic device that is accessing the live video resource from the target live room. It can also be understood that the electronic device associated with the target live room is an electronic device that is displaying the live video from the target live room. That is, the electronic device associated with the target live room is an electronic device used by an audience of the target live room.

Therefore, the second target device distributes the virtual gift video along with the anchor's live stream when receiving an application to present a customized virtual gift video to the anchor of the target live room, saving traffic on a content distribution network.

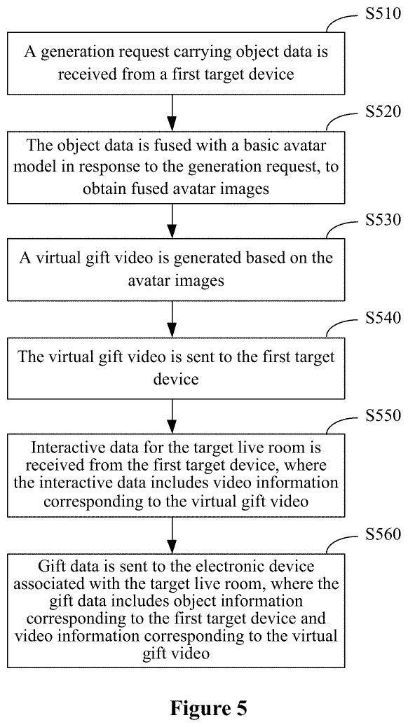

FIG. 5 is a schematic flowchart of a method for sending a virtual gift video according to another embodiment of the present disclosure.

In other embodiments of the present disclosure, the method for sending a virtual gift video may further include the following steps S510 to S560.

In S510, a generation request carrying object data is received from the first target device.

In S520, the object data is fused with a basic avatar model in response to the generation request, to obtain fused avatar images.

In S530, a virtual gift video is generated based on the avatar images.

In S540, the virtual gift video is sent to the first target device, where the virtual gift video is used to be displayed in a target gift tray page of the first target device.

S510 to S540 are similar to S310 to S340 shown in FIG. 3, which will not be repeated herein.

In S550, interactive data for the target live room is received from the first target device, where the interactive data includes the video information corresponding to the virtual gift video.

S550 is similar to S450 shown in FIG. 4, which will not be repeated herein.

In S560, gift data is sent to the electronic device associated with the target live room, where the gift data includes object information corresponding to the first target device and video information corresponding to the virtual gift video.

In an embodiment of the present disclosure, the second target device may directly send the gift data to the electronic device associated with the target live room after receiving the video information. Thus, the electronic device associated with the target live room may display the virtual gift video and the object information of the user presenting the virtual gift video in a live video display interface of the target live room, based on the gift data.

In an embodiment, after receiving the video information corresponding to the virtual gift video, the electronic device associated with the target live room may query the virtual gift video corresponding to the video information in multiple pre-stored virtual gift videos, and overlay and display the queried virtual gift video onto a live video content of the target live room.

In other embodiments of the present disclosure, the gift data may also include the presentation time of the virtual gift video. The electronic device associated with the target live room displays, based on the gift data, the virtual gift video and the object information of the user presenting the virtual gift video in the live video display interface of the target live room, based on the presentation time of the virtual gift video.

For example, when electronic device associated with the target live room receives multiple pieces of gift data, a display order of the virtual gift videos corresponding to the multiple pieces of gift data is sorted based on the presentation times of the virtual gift videos, and then the virtual gift videos are displayed in the sorted display order in sequence.

In an embodiment of the present disclosure, in order to enable the electronic device associated with the target live room to display the virtual gift video based on the video information corresponding to the virtual gift video, after S540 and before S560, the video generation method may further include: sending the virtual gift video to the electronic device associated with the target live room, to store the virtual gift video into the electronic device associated with the target live room.

In an embodiment, the method for sending the virtual gift video may further include:
sending video information corresponding to the virtual gift video to an electronic device associated with the target live room, to store the video information corresponding to the virtual gift video into the electronic device associated with the target live room.

Therefore, the second target device separately distributes the virtual gift video when receiving an application to present a customized virtual gift video to the anchor of the target live room, to improve the display level of the virtual gift video. In this way, the virtual gift video is not obscured by other contents, ensuring the display effect of the virtual gift video.

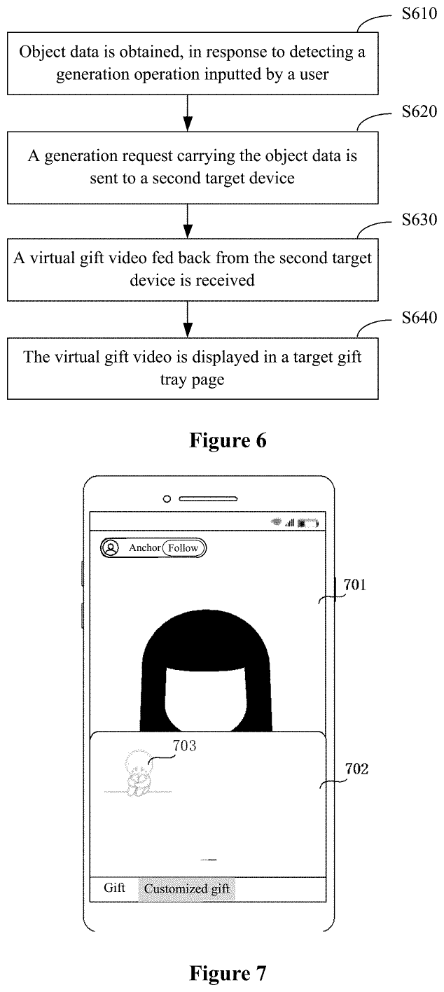

FIG. 6 is a schematic flowchart of a video display method according to an embodiment of the present disclosure.

As shown in FIG. 6, the video display method includes the following steps S610 to S640.

In S610 object data is obtained, in response to detecting a generation operation inputted by a user.

When a user wants to customize a virtual gift video, the user may input in a first target device a generation operation for generating the virtual gift video.

The generation operation includes a trigger operation on a control for triggering the generation of the virtual gift video. Specifically, the trigger operation may be a click operation, a double click operation, a long press operation, or a voice operation, etc.

For example, the control for triggering the generation of the virtual gift video may be a generation button for triggering the generation of the virtual gift video in a target gift tray page.

The target gift tray page may be a customized gift tray page of a live video platform (such as in a live video application), may also be a customized gift tray page in a live video display interface of any live video room of the live video platform, may also be a customized gift tray page in any interface of a platform with the function of customizing a virtual gift video, which will not be limited herein.

The first target device obtains object data uploaded by the user, after detecting the generation operation inputted by the user.

The object data may include at least one of object information, an object posture image, and a part image of an object.

In an embodiment, the object information may include at least one of object identification, an object nickname, and an object display picture.

In an embodiment, the object posture image may include at least one of a first posture image for a first part of the object and a second posture image for a second part of the object.

It should be noted that the object data has been illustrated in the embodiment shown in FIG. 3, which will not be further repeated herein.

In S620, a generation request carrying the object data is sent to a second target device.

In an embodiment of the present disclosure, the first target device generates the generation request carrying the object data by using the object data, and sends the generation request carrying the object data to the second target device.

The generation request is used to enable the second target device to provide feedback of the virtual gift video. The virtual gift video is generated by fusing the object data with a basic avatar model, which has been explained in the embodiment shown in FIG. 3 and will not be repeated here.

In S630, a virtual gift video fed back from the second target device is received.

In an embodiment of the present disclosure, the first target device receives the virtual gift video fed back from the second target device.

In an embodiment, the second target device may further send video information corresponding to the virtual gift video to the first target device. The first target device receives the video information corresponding to the virtual gift video fed back from the second target device, and stores the video information corresponding to the virtual gift video.

In an embodiment, the second target device may further send a virtual gift preview image corresponding to the virtual gift video to the first target device.

In S640, the virtual gift video is displayed in a target gift tray page.

In an embodiment of the present disclosure, the first target device may display the virtual gift preview image of the received virtual gift video in the target gift tray page.

FIG. 7 is a schematic diagram of a gift tray interface according to an embodiment of the present disclosure. As shown in FIG. 7, the first target device displays a live video display interface 701 of a target live room of a video live platform. A customized gift tray page 702 is displayed in the live video display interface 701. A virtual gift preview image 703 of the received virtual gift video is displayed in the customized gift tray page 702 to distinguish the customized virtual gift video from other virtual gift videos.

In an embodiment of the present disclosure, the object data can be fused with the basic avatar model to obtain the fused avatar images, and a virtual gift video to be displayed in the target gift tray page is generated based on the avatar images to achieve automatic generation of the virtual gift video, thereby shortening the production cycle of the virtual gift video and saving the production cost of the virtual gift video.

In another implementation of the present disclosure, in the case that the object data includes at least one of an object posture image and a part image of an object, and the object posture image includes at least one of a first posture image for a first part of the object and a second posture image for a second part of the object, S610 may specifically include:

obtaining a user video or a user image which contains the object data and is inputted by a user, in response to detecting the generation operation inputted by a user.

In some embodiments, before a user video or a user image which contains the object data and is inputted by a user is obtained, a data upload interface may be displayed, to capture or select a user video or a user image containing the object data in the data upload interface by the user. Then, the user video or the user image containing the object data is input to the first target device.

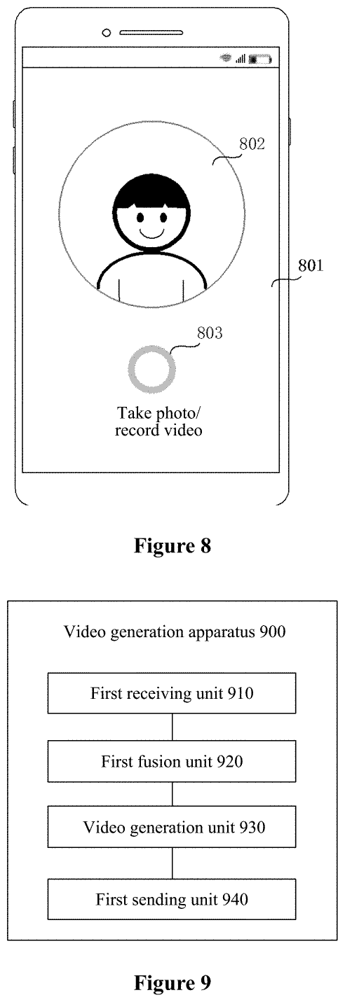

FIG. 8 is a schematic diagram of a data upload interface according to an embodiment of the present disclosure. As shown in FIG. 8, a data upload interface 801 is displayed on the first target device. A preview window 802 for capturing a user video or a user image, and a target button 803 for triggering the capture of a user video or a user image are displayed on the data upload interface 801. A user may capture a user image by clicking the target button 803, and preview the captured user image in the preview window 802. The user may also capture a user video by long-pressing the target button 803, and preview the captured user video in the preview window 802.

In an embodiment, the object posture image may be an image frame or the user image in the user video. The part image of the object may also be an image frame or the user image in the user video. That is, the user video and the user image may include at least one of the object posture image and the part image of the object.

In other embodiments, before S610, a data upload interface may be displayed, to capture or select the user video or the user image containing the object data in the data upload interface by the user. Then, the user video or the user image containing the object data is input to the first target device. The first target device obtains the object data already inputted by the user, when detecting the generation operation inputted by the user.

The method for inputting the user video or the user image containing the object data by the user has been explained above, which will not be repeated herein.

Therefore, in the embodiments of the present disclosure, the user can upload the object data more conveniently and quickly.

In an embodiment of the present disclosure, after S640, when a user wants to customize a virtual gift video, the user inputs a sending operation for the displayed virtual gift video in the target gift tray page. The first target device sends the video information corresponding to the virtual gift video to the second target device, in response to detecting the sending operation for the virtual gift video.

In an embodiment, the sending operation may be a click operation, a double click operation, a long press operation, or a voice operation on the virtual gift video.

In an embodiment, the first target device further plays the virtual gift video in a current interface, after detecting the sending operation for the virtual gift video.

In an embodiment, after detecting the sending operation for the virtual gift video, the first target device obtains the video information of the virtual gift video, queries the virtual gift video corresponding to the video information in multiple pre-stored virtual gift videos, and plays the queried virtual gift video.

Taking the first target device displaying the live video display interface of the target live room as an example, the user clicks the virtual gift video in the target gift tray page in the live video display interface. The first target device sends the video information corresponding to the virtual gift video to the second target device, in response to the click operation. In addition, the first target device queries the virtual gift video corresponding to the video information in multiple pre-stored virtual gift videos, and overlays and plays the queried virtual gift video on a live video content of the target live room.

Therefore, after the user presents the virtual gift video to an anchor, the virtual gift video is played on the electronic device used by the user.

FIG. 9 is a schematic structural diagram showing a video generation apparatus according to an embodiment of the present disclosure.

In some embodiments, the video generation apparatus 900 may be set in the second target device mentioned above. The second target device may be a server 120 on a server side shown in FIG. 1 or the second electronic device 220 in FIG. 2. The second electronic device 220 may be a device with communication functions, such as a mobile phone, a tablet computer, a desktop computer, a laptop, a car terminal, a wearable device, an all-in-one machine, a smart home device; and may also be a device simulated by a virtual machine or a simulator. The server 120 may be a device with storage and computing capabilities, such as a cloud server or a cluster of servers.

As shown in FIG. 9, the video generation apparatus 900 includes a first receiving unit 910, a first fusion unit 920, a video generation unit 930, and a first sending unit 940.

The first receiving unit 910 is configured to receive a generation request carrying object data from a first target device.

The first fusion unit 920 is configured to fuse the object data with a basic avatar model in response to the generation request, to obtain fused avatar images.

The video generation unit 930 is configured to generate a virtual gift video based on the avatar images.

The first sending unit 940 is configured to send the virtual gift video to the first target device, where the virtual gift video is used to be displayed in a target gift tray page of the first target device.

In the embodiment of the present disclosure, the object data is fused with the basic avatar model to obtain the fused avatar images, and a virtual gift video to be displayed in the target gift tray page is generated based on the avatar images to achieve automatic generation of the virtual gift video, thereby shortening the production cycle of the virtual gift video and saving the production cost of the virtual gift video.

In some embodiments of the present disclosure, the object data may include at least one of object information, an object posture image, and a part image of an object.

In an embodiment, the object information may include at least one of object identification, an object nickname, and an object display picture.

In an embodiment, the object posture image may include at least one of a first posture image for a first part of the object and a second posture image for a second part of the object.

In some embodiments, the object data may include the object posture image; and the object posture image may include at least one of the first posture image for the first part of the object and the second posture image for a second part of the object.

Correspondingly, the first fusion unit 920 is further configured to perform posture transfer on the basic avatar model using the object posture image, to generate the fused avatar images.

In some embodiments, the object data may include the part image of the object.

Correspondingly, the first fusion unit 920 is further configured to update the basic avatar model using the part image of the object, to generate the fused avatar images.

In some embodiments, the object data may include object information; and the object information may include at least one of object identification, an object nickname, and an object display picture.

Correspondingly, the first fusion unit 920 is further configured to generate avatar images corresponding to the basic avatar model; and add the object information to a preset position of the avatar images based on a preset information addition method, to generate the fused avatar images.

In some embodiments of the present disclosure, the video generation apparatus 900 may further include a third receiving unit, a second obtaining unit, a second fusion unit, and a third sending unit.

The third receiving unit is configured to receive interactive data for a target live room from the first target device, where the interactive data includes video information corresponding to the virtual gift video.

The second obtaining unit is configured to obtain the virtual gift video corresponding to the video information.

The second fusion unit is configured to fuse the virtual gift video with a live video of the target live room, to form a fused live video.

The third sending unit is configured to send the fused live video to an electronic device associated with the target live room.

In other embodiments of the present disclosure, the video generation apparatus 900 may further include a fourth receiving unit and a fourth sending unit.

The fourth receiving unit is configured to receive interactive data for the target live room from the first target device, where the interactive data includes video information corresponding to the virtual gift video.

The fourth sending unit is configured to send gift data to the electronic device associated with the target live room, where the gift data includes object information corresponding to the first target device and video information corresponding to the virtual gift video.

It should be noted that the video generation apparatus 900 shown in FIG. 9 may perform various steps in the method embodiments shown in FIGS. 3 to 5, and implement various processes and effects in the method embodiments shown in FIGS. 3 to 5, which will not be further described here.

FIG. 10 is a schematic structural diagram showing a video display apparatus according to an embodiment of the present disclosure.

In some embodiments, the video display apparatus 1000 may be set in the first target device. The first target device may be the electronic device 110 on a client side shown in FIG. 1 or the first electronic device 210 shown in FIG. 2. The electronic device 110 and first electronic device 210 may be a device with communication functions, such as a mobile phone, a tablet, a desktop computer, a laptop, a car terminal, a wearable device, an all-in-one machine, a smart home device; and may also be a device simulated by a virtual machine or a simulator.

As shown in FIG. 10, the video display apparatus 1000 may include a first obtaining unit 1010, a second sending unit 1020, a second receiving unit 1030, and a video display unit 1040.

The first acquisition unit 1010 is configured to obtain object data, in response to detecting a generation operation inputted by a user.

The second sending unit 1020 is configured to send a generation request carrying the object data to a second target device, where the generation request is used to provide on a virtual gift video that is fed back from the second target device and generated by fusing the object data with a basic avatar model.

The second receiving unit 1030 is configured to receive the virtual gift video fed back from the second target device.

The video display unit 1040 is configured to display the virtual gift video in a target gift tray page.

In the embodiment of the disclosure, the object data is fused with the basic avatar model to obtain the fused avatar images, and a virtual gift video to be displayed in the target gift tray page is generated based on the avatar images to achieve automatic generation of the virtual gift video, thereby shortening the production cycle of the virtual gift video and saving the production cost of the virtual gift video.

In some embodiments of the present disclosure, the object data may include at least one of object information, an object posture image, and a part image of an object.

In an embodiment, the object information may include at least one of object identification, an object nickname, and an object display picture.

In an embodiment, the object posture image may include at least one of a first posture image for a first part of the object and a second posture image for a second part of the object.

In some embodiments of the present disclosure, the object data may include at least one of an object posture image and a part image of an object, and the object posture image may include at least one of a first posture image for a first part of the object and a second posture image for a second part of the object.

Correspondingly, the first obtaining unit 1010 is further configured to obtain a user video which contains object data and is inputted by a user, in response to detecting a generation operation inputted by a user.

It should be noted that the video display apparatus 1000 shown in FIG. 10 may perform various steps in the method embodiments shown in FIGS. 6 to 8, and implement various processes and effects in the method embodiments shown in FIGS. 6 to 8, which will not be further described herein.

A computing device is also provided in the present embodiment of the present disclosure. The computing device includes a processor and a memory, where the memory is used to store executable instructions. The processor is configured to read the executable instructions from the memory and execute the executable instructions to implement the video generation method or the video display method described in the above embodiments.

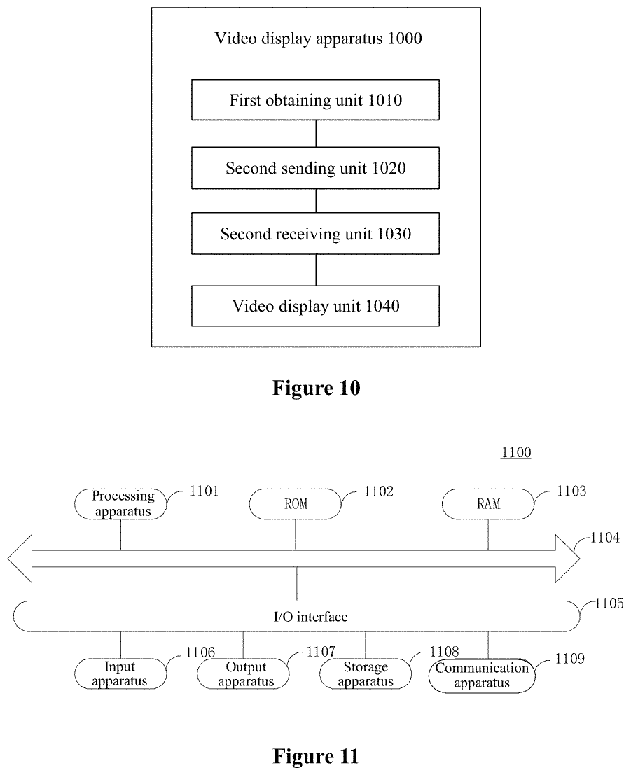

FIG. 11 is a schematic structural diagram showing a computing device according to an embodiment of the present disclosure. A specific reference is made to FIG. 11 below, which shows a schematic structural diagram of a computing device 1100 for implementing the embodiments of the present disclosure.

The computing device 1100 in an embodiment of the present disclosure may be the first target device for executing the video display method, or may be the second target device for executing the video generation method. The first target device may be an electronic device, such as the electronic device 110 on a client side shown in FIG. 1 or the first electronic device 210 shown in FIG. 2. The second target device may be an electronic device or a server, such as server 120 in a server side shown in FIG. 1 or the second electronic device 220 in FIG. 2. The electronic device may include, but is not limited to, mobile terminals, such as, a mobile phone, a laptop, a digital broadcast receiver, a PDA (personal digital assistant), a PAD (tablet), a PMP (portable multimedia player), a vehicle-mounted terminal (such as an in-vehicle navigation terminal), a wearable device; and fixed terminals such as a digital TV, a desktop computer, a smart home device. The server may be a device with storage and computing capabilities, such as a cloud server or a cluster of servers.

It should be noted that the computing device 1100 shown in FIG. 11 is only an example and should not impose any limitations on the functionality and usage scope of the embodiments of the present disclosure.

As shown in FIG. 11, the computing device 1100 may include a processing apparatus 1101, such as a central processor or a graphics processor, which may execute various proper operations and processing based on a program stored in a Read Only Memory (ROM) 1102 or a program loaded from a storage apparatus 1108 into a Random Access Memory (RAM) 1103. The RAM 1103 is further configured to store various programs and data demanded by the computing device 1100. The processing apparatus 1101, the ROM 1102 and the RAM 1103 are connected to each other through a bus 1104. An Input/output (I/O) interface 1105 is also connected to the bus 1104.

Generally, the I/O interface 1105 may be connected to: an input apparatus 1106, such as a touch screen, a touch panel, a keyboard, a mouse, a camera, a microphone, an accelerometer, and a gyroscope; an output apparatus 1107, such as a liquid crystal display (LCD), a speaker, and a vibrator; a storage apparatus 1108 such as a magnetic tape and a hard disk; and a communication apparatus 1109. The communication apparatus 1109 enables wireless or wired communication between the computing device 1100 and other devices for data exchanging. Although FIG. 11 shows a computing device 1100 having various apparatus, it should be understood that the illustrated apparatus are not necessarily required to all be implemented or embodied. Alternatively, more or fewer apparatuses may be implemented or included.

A computer-readable storage medium storing a computer program is also provided in an embodiment of the present disclosure. The computer program, when executed by the processor, causes the processor to perform the video generation method or the video display method described in the above embodiments.

Particularly, according to the embodiments of the present disclosure, the process described above in conjunction with flowcharts may be implemented as a computer software program. For example, a computer program product is provided as an embodiment in the present disclosure, including a computer program carried on a non-transitory computer readable medium. The computer program includes program codes for performing the method shown in the flowchart. In the embodiment, the computer program may be downloaded and installed from the network via the communication apparatus 1109, or installed from the storage apparatus 1108, or installed from the ROM 1102. When the computer program is executed by the processing apparatus 1101, the functions defined in the video generation method or the video display method according to the embodiments of the present disclosure are performed.

It should be noted that the computer readable medium mentioned in the present disclosure may be a computer readable signal medium or a computer readable storage medium or any combination thereof. The computer readable storage medium may be but is not limited to, a system, an apparatus, or a device in an electronic, magnetic, optical, electromagnetic, infrared, or semi-conductive form, or any combination thereof. More specific examples of the computer readable storage medium may be, but is not limited to, an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), a light storage device, a magnetic storage device or any combination thereof. In the present disclosure, the computer readable storage medium may be any tangible medium containing or storing a program, and the program may be used by or in combination with an instruction execution system, apparatus, or device. In the present disclosure, the computer readable signal medium may be a data signal transmitted in a baseband or transmitted as a part of a carrier wave and carrying computer readable program codes. The transmitted data signal may be in various forms, including but not limited to an electromagnetic signal, an optical signal or any proper combination thereof. The computer readable signal medium may also be any computer readable medium other than the computer readable storage medium, and can send, propagate or transmit programs to be used by or in combination with an instruction execution system, apparatus or device. The program codes stored in the computer readable medium may be transmitted via any proper medium including but not limited to: a wire, an optical cable, RF (radio frequency) and the like, or any proper combination thereof.

In some embodiments, the client and server can communicate using any currently known or future developed network protocol such as HTTP, and can be interconnected with any form or medium of digital data communication (such as a communication network). Examples of a communication network include a local area network (“LAN”), a wide area network (“WAN”), the Internet Work (for example, the Internet), and a peer-to-peer network (for example, an ad hoc peer-to-peer network), as well as any currently known network or a future developed network.

The above-mentioned computer readable medium may be incorporated in the electronic device, or may exist alone without being assembled into the computing device.

The above-mentioned computer-readable medium carries one or more programs. The one or more programs, when executed by the computing device, configure the computing device to:
receive a generation request carrying object data from a first target device; in response to the generation request, fuse the object data with a basic avatar model to obtain fused avatar images; generate a virtual gift video based on the avatar images; send the virtual gift video to the first target device, where the virtual gift video is used to be displayed in a target gift tray page of the first target device;
or, obtain object data, in response to detecting a generation operation inputted by a user; send a generation request carrying the object data to a second target device, where the generation request is used to provide a virtual gift video that is fed back from the second target device and generated by fusing the object data with the basic avatar model; receive the virtual gift video fed back from the second target device; and display the virtual gift video in the target gift tray page.

In an embodiment of the present disclosure, the computer program codes for performing the operations disclosed in the present disclosure may be written in one or more programming languages or combinations thereof. The programming languages include, but not limit to an object-oriented programming language, such as Java, Smalltalk, and C++, and a conventional procedural programming language, such as C language or a similar programming language. The program code may be executed entirely on a user computer, partially on the user computer, as a standalone software package, partially on the user computer and partially on a remote computer, or entirely on the remote computer or a server. In a case involving a remote computer, the remote computer may be connected to a user computer or an external computer through any kind of network including local area network (LAN) or wide area network (WAN). For example, the remote computer may be connected through Internet connection by an Internet service provider.

Flow charts and block charts in the drawings illustrate the architecture, functions and operations that can be implemented by the system, method and computer program product according to the embodiments of the present disclosure. In this regard, each block in the flowchart or the block diagram may represent a module, a program segment, or a part of code. The module, the program segment, or the part of code includes one or more executable instructions used for implementing specified logic functions. It should be noted that, in some alternative implementations, the functions marked in blocks may be performed in an order different from the order shown in the drawings. For example, two blocks shown in succession may actually be executed in parallel, or sometimes may be executed in a reverse order, which depends on the functions involved. It should also be noted that each of the block in the block diagram and/or flowchart and a combination of the blocks in the block diagram and/or flowchart may be implemented by a dedicated hardware-based system that performs specified functions or operations, or may be realized by a combination of dedicated hardware and computer instructions.

The units involved in the embodiments of the present disclosure may be implemented in a software manner, and may also be implemented in a hardware manner. The name of the unit does not constitute a limitation of the unit under any circumstances.

The functions described herein above may be performed, at least in part, by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and the like.

In the context of the present disclosure, the machine readable medium may be a tangible medium that may contain or store a program, and the program may be used by or in connection with an instruction execution system, apparatus or device. The machine readable medium may be a machine readable signal medium or a machine readable storage medium. The computer readable medium may include, but is not limited to, system, an apparatus, or a device in an electronic, magnetic, optical, electromagnetic, infrared, or semi-conductive form, or any suitable combination thereof. More specific examples of the machine readable storage medium may include, one or more wire based electrical connections, a portable computer disk, a hard disk, a random access memory (RAM), a read-only memory (ROM), an erasable programmable read-only memory (EPROM or Fast flash memory), an optical fiber, a portable compact disc read-only memory (CD-ROM), an optical storage device, a magnetic storage device or any suitable combination thereof.

The above description includes merely preferred embodiments of the present disclosure and explanations of technical principles used. Those skilled in the art should understand that the scope of the present disclosure is not limited to the technical solution formed by combination of the technical features described above, but also covers other technical solutions formed by any combination of the above technical features or the equivalent features of the technical features without departing from the concept of the present disclosure. For example, a technical solution formed by interchanging the above features and technical features having similar functions as disclosed, but not limited to, in the present disclosure with each other is also covered with the scope of the present disclosure.

It should be noted that although the various operations are described in a specific order, it should not be understood that these operations are required to be performed in the specific order or performed in a sequential order. Under certain circumstances, multitasking and parallel processing may be advantageous. Although multiple implementation details are included in the above descriptions, the details should not be interpreted as limitations to the scope of the present disclosure. Some features described in a separate embodiment may be implemented in combination in a separate embodiment. Conversely, the features described in a separate embodiment may be implemented in multiple embodiments individually or in any suitable sub-combination.

Although the subject matter has been described in language specific to structural features and/or logical actions of the method, it should be understood that the subject matter defined in the appended claims are unnecessarily limited to the specific features or actions described above. The specific features and actions described above are merely exemplary forms of implementing the claims.

1. A video generation method, comprising:
receiving a generation request carrying object data from a first target device;
fusing the object data with a basic avatar model in response to the generation request, to obtain fused avatar images;
generating a virtual gift video based on the avatar images; and
sending the virtual gift video to the first target device, wherein the virtual gift video is used to be displayed in a target gift tray page of the first target device.

2. The method according to claim 1, wherein the object data comprises at least one of object information, an object posture image, and a part image of an object;
wherein the object information comprises an object identification or an object nickname; and the object posture image comprises at least one of a first posture image for a first part of the object and a second posture image for a second part of the object.

3. The method according to claim 1, wherein the object data comprises an object posture image, and the object posture image comprises at least one of a first posture image for a first part of an object and a second posture image for a second part of the object; and
the fusing the object data with a basic avatar model to obtain fused avatar images comprises:
performing posture transfer on the basic avatar model using the object posture image, to generate the fused avatar images.

4. The method according to claim 1, wherein the object data comprises a part image of an object; and
the fusing the object data with a basic avatar model to obtain a fused avatar image comprises:
updating the basic avatar model using the part image of the object to generate the fused avatar images.

5. The method according to claim 1, wherein the object data comprises object information; and the object information comprises an object identification or an object nickname; and
the fusing the object data with a basic avatar model to obtain a fused avatar image comprises:
generating avatar images corresponding to the basic avatar model; and
adding the object information to a preset position of each of the avatar images based on a preset information addition method, to generate the fused avatar images.

6. The method according to claim 1, wherein after sending the virtual gift video to the first target device, the method further comprises:
receiving interactive data for a target live room from the first target device, wherein the interactive data comprises video information corresponding to the virtual gift video;
obtaining the virtual gift video corresponding to the video information;
fusing the virtual gift video with a live video of the target live room to form a fused live video; and
sending the fused live video to the electronic device associated with the target live room.

7. The method according to claim 1, wherein after sending the virtual gift video to the first target device, the method further comprises:
receiving interactive data for a target live room from the first target device, wherein the interactive data comprises video information corresponding to the virtual gift video; and
sending gift data to an electronic device associated with the target live room, wherein the gift data comprises object information corresponding to the first target device and video information corresponding to the virtual gift video.

8. A video display method, comprising:
obtaining object data, in response to detecting a generation operation inputted by a user;
sending a generation request carrying the object data to a second target device, wherein the generation request is configured to provide a virtual gift video that is fed back from the second target device and generated by fusing the object data with a basic avatar model;
receiving the virtual gift video fed back from the second target device; and
displaying the virtual gift video in a target gift tray page.

9. The method according to claim 8, wherein the object data comprises at least one of object information, an object posture image, and a part image of an object;
wherein the object information comprises an object identification or an object nickname; and the object posture image comprises at least one of a first posture image for a first part of the object and a second posture image for a second part of the object.

10. The method according to claim 8, wherein the object data comprises at least one of an object posture image and a part image of an object, and the object posture image comprises at least one of a first posture image for a first part of the object and a second posture image for a second part of the object;
the obtaining object data, in response to detecting a generation operation inputted by a user comprises:
obtaining a user video which contains the object data and is inputted by the user, in response to detecting the generation operation inputted by a user.

11. A computing device, comprising:
a processor;
a memory configured to store executable instructions;
wherein the processor is configured to read the executable instructions from the memory and execute the executable instructions to
receive a generation request carrying object data from a first target device; fuse the object data with a basic avatar model in response to the generation request, to obtain fused avatar images; generate a virtual gift video based on the avatar images; and send the virtual gift video to the first target device, wherein the virtual gift video is used to be displayed in a target gift tray page of the first target device; or
obtain object data, in response to detecting a generation operation inputted by a user; send a generation request carrying the object data to a second target device, wherein the generation request is configured to provide a virtual gift video that is fed back from the second target device and generated by fusing the object data with a basic avatar model; receive the virtual gift video fed back from the second target device; and display the virtual gift video in a target gift tray page.

12. The computing device according to claim 11, wherein the object data comprises at least one of object information, an object posture image, and a part image of an object;
wherein the object information comprises an object identification or an object nickname; and the object posture image comprises at least one of a first posture image for a first part of the object and a second posture image for a second part of the object.

13. The computing device according to claim 11, wherein the object data comprises an object posture image, and the object posture image comprises at least one of a first posture image for a first part of an object and a second posture image for a second part of the object; and
wherein the processor is configured to read the executable instructions from the memory and execute the executable instructions to:
perform posture transfer on the basic avatar model using the object posture image, to generate the fused avatar images.

14. The computing device according to claim 11, wherein the object data comprises a part image of an object; and
wherein the processor is configured to read the executable instructions from the memory and execute the executable instructions to:
update the basic avatar model using the part image of the object to generate the fused avatar images.

15. The computing device according to claim 11, wherein the object data comprises object information; and the object information comprises an object identification or an object nickname; and
wherein the processor is configured to read the executable instructions from the memory and execute the executable instructions to:
generate avatar images corresponding to the basic avatar model; and
add the object information to a preset position of each of the avatar images based on a preset information addition method, to generate the fused avatar images.

16. The computing device according to claim 11, wherein after the virtual gift video is sent to the first target device, the processor is configured to read the executable instructions from the memory and execute the executable instructions to:
receive interactive data for a target live room from the first target device, wherein the interactive data comprises video information corresponding to the virtual gift video;
obtain the virtual gift video corresponding to the video information;
fuse the virtual gift video with a live video of the target live room to form a fused live video; and
send the fused live video to the electronic device associated with the target live room.

17. The computing device according to claim 11, wherein after the virtual gift video is sent to the first target device, the processor is configured to read the executable instructions from the memory and execute the executable instructions to:
receive interactive data for a target live room from the first target device, wherein the interactive data comprises video information corresponding to the virtual gift video; and
send gift data to an electronic device associated with the target live room, wherein the gift data comprises object information corresponding to the first target device and video information corresponding to the virtual gift video.

18. The computing device according to claim 11, wherein the object data comprises at least one of an object posture image and a part image of an object, and the object posture image comprises at least one of a first posture image for a first part of the object and a second posture image for a second part of the object;
wherein the processor is configured to read the executable instructions from the memory and execute the executable instructions to:
obtain a user video which contains the object data and is inputted by the user, in response to detecting the generation operation inputted by a user.

19. A non-transitory computer-readable storage medium storing a computer program, wherein the computer program, when executed by a processor, causes the processor to
receive a generation request carrying object data from a first target device; fuse the object data with a basic avatar model in response to the generation request, to obtain fused avatar images; generate a virtual gift video based on the avatar images; and send the virtual gift video to the first target device, wherein the virtual gift video is used to be displayed in a target gift tray page of the first target device; or
obtain object data, in response to detecting a generation operation inputted by a user; send a generation request carrying the object data to a second target device, wherein the generation request is configured to provide a virtual gift video that is fed back from the second target device and generated by fusing the object data with a basic avatar model; receive the virtual gift video fed back from the second target device; and display the virtual gift video in a target gift tray page.
